(19) United States
(12) Patent Application Publication
(10) Pub. No.: US 2025/0022285 A1
(43) Pub. Date: Jan. 16, 2025

(54) Method Of Improving Driving Behavior

(71) Applicant: Advanced Automobile Solutions, Ltd., Wembley (GB)

(72) Inventor: Mark Miller, Westover Hill (GB)

(21) Appl. No.: 18/752,392

(22) Filed: Jun. 24, 2024

Related U.S. Application Data
(60) Provisional application No. 63/526,892, filed on Jul. 14, 2023.

(51) Int. Cl. G06V 20/58; B60Q 9/00; G06Q 40/08; G06V 10/70; G06V 20/40; G06V 20/59; G08G 1/16

(52) U.S. Cl. CPC G06V 20/58; B60Q 9/008; G06Q 40/08; G06V 10/768; G06V 20/49; G06V 20/597; G08G 1/16

(57) ABSTRACT

Processing burden of a computing system, in identifying driving risk for a driver of a motor vehicle, is reduced by using image data captured without having been triggered by adverse driving events. Risk assessment is preferably based upon analysis of the image data with respect to at least one of ambient traffic density, off-road hazard, on-road hazard, complexity of a roadway upon which the vehicle is being driven, behavior of a vehicle within sight range of a driver of the vehicle, and existence of pedestrians within sight range of the driver. The computing system preferably uses machine learning/artificial intelligence software to derive the risk assessment. The adverse driving events preferably not used to trigger capturing of the image data include of speeding, driver distraction, hard braking, swerving, collision, and near collision. The risk assessment can advantageously trigger delivery of a message to the driver.

### PRIORITY CLAIM

This application claims priority to U.S. provisional patent application Ser. No. 63/526,892, filed Jul. 14, 2023, titled “Systems and Methods For Using Experiential Data To Guide Driving Behavior”. This and all other referenced extrinsic materials are incorporated herein by reference in their entirety. Where a definition or use of a term in a reference that is incorporated by reference is inconsistent or contrary to the definition of that term provided herein, the definition or use of that term provided herein is deemed to be controlling.

### FIELD OF THE INVENTION

The field of the invention is systems and methods for providing and receiving user opinions and opinion summaries.

### BACKGROUND

The following description includes information that may be useful in understanding the present invention. It is not an admission that any of the information provided herein is prior art or relevant to the presently claimed invention, or that any publication specifically or implicitly referenced is prior art.

Prior art risk assessment, and corresponding insurance rates, are based upon generalized common sense parameters. For example, some insurance companies offer lower rates to drivers that generally drive below posted speed limits, and generally avoid hard braking. See for example Progressive™ Insurance's Snapshot™ program to provide lower rates for “good drivers”. https://www.progressive.com/auto/discounts/snapshot/. That approach is, however, problematic because such parameters might inaccurately predict risk. A driver that generally drives slightly over the speed limit and/or tends to brake hard, might actually have fewer accidents.

Prior art risk assessment also fails to account for how risks might differ for a given driver operating different vehicles. It might be that gradually slowing down while approaching a traffic light in an electric vehicle with regenerative braking correlates with relatively lower risk, while the same driver doing the same thing in a vehicle without regenerative braking correlates with relatively higher risk

Still further, risk assessment based upon collection of data triggered by adverse driving event can require collection and processing of an enormous amount of data.

In short, the prior art risk assessment tools are poor predictors of accidents and other adverse outcomes, and are impractical to implement for the general population of drivers.

Thus, there is still a need for improved systems and methods to ascertain driver risk that is based less (or not at all) on adverse driving events such as driver distraction, speeding, and accidents, and more (or entirely) on circumstances of ambient conditions in ordinary driving.

### SUMMARY OF THE INVENTION

The inventive subject matter provides systems and methods that reduce processing burden of a computing system, in identifying driving risk for a driver of a motor vehicle, by using image data captured without having been triggered by adverse driving events.

The computing system used to analyze the captured data can be on or in the vehicle (as for example in a cell phone, and can additionally or alternatively be distal to the vehicle.

Captured segments can have different lengths, and there can be different intervals between successive segments. Segment lengths and/or intervals can be random or determined. Captured image data can include video and/or still photographs. In some embodiments at least 20% of the image data used in producing the risk assessment is not triggered by an adverse driving event. More preferably at least 50%, 75%, or even 90% of the image data used in producing the risk assessment is not triggered by an adverse driving event.

The risk assessment is preferably based upon analysis of the processed segments with respect to at least one of ambient traffic density, off-road hazard, on-road hazard, complexity of a roadway upon which the vehicle is being driven, behavior of a vehicle within sight range of a driver of the vehicle, and existence of pedestrians within sight range of the driver. The computing system preferably uses machine learning/artificial intelligence software to derive the risk assessment.

The adverse driving events preferably not used to trigger capturing of the image data include of speeding, driver distraction, hard braking, swerving, collision, and near collision.

The risk assessment can advantageously trigger delivery of a message to the driver. Contemplated messages include honking of the horn or other non-verbal sounds, verbal phrases, and images visible to the driver.

### BRIEF DESCRIPTION OF THE DRAWING

FIG. 1 is a diagram of an automobile or other motor vehicle driving along a windy congested road, with an off-road hazard, and on-road hazard, and multiple pedestrians all within sight range of the driver.

FIG. 2 is a diagram of image data being captured by on-board cameras, transmitted to a distal computing system, and a risk assessment message being sent to the driver.

FIG. 3 is a diagram 300 of an exemplary timeline of a period of vehicle motion, depicting segments of image data capture and instances of adverse driving events.

### DETAILED DESCRIPTION

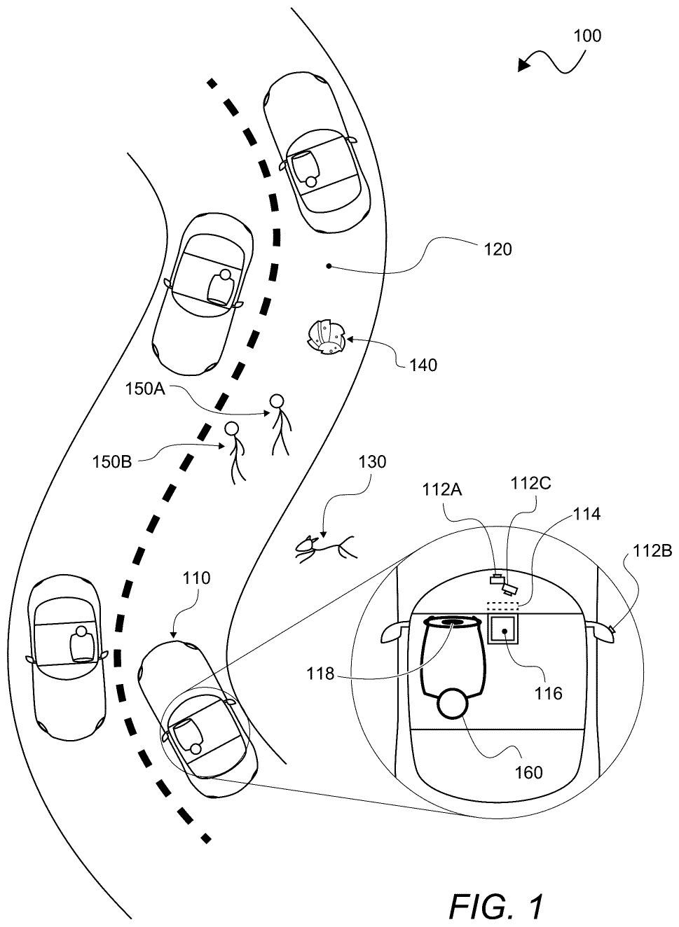

FIG. 1 is a schematic 100 of an automobile or other motor vehicle 110 driving along a windy congested road 120, with an off-road hazard 130, an on-road hazard 140, and multiple pedestrians 150A, 150B all within sight range of the driver 160. Carried on or within vehicle 110 are multiple external environment-facing cameras 112A, 112B, an internal facing camera 12C, a local computer system 114, a display 116, and a speaker, horn or other sound producing device 118.

At least one of the cameras 112A-112C can be a camera of a cell phone or dash cam. Any one or more of the local computer system 114, a display 116, sound producing device 118 can also be components of a camera of a cell phone or dash cam.

Contemplated congested roads include situations where there are at least 10 motor vehicles within 50 meters of the motor vehicle 110.

Contemplated off-road hazards include glare and other environmental conditions, off-road construction noises and visuals, attention-attracting signs, architecture, and off-road pedestrians and bicycles.

Contemplated on-road hazards include ice, snow, standing water, gravel, sand, potholes, hubcaps, mattresses, fallen branches, animal carcasses and other debris, and on-road pedestrians and bicycles.

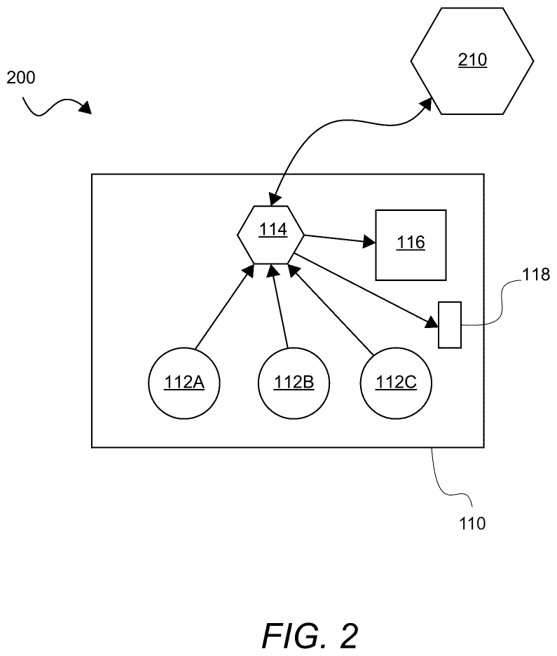

FIG. 2 is a diagram 200 of image data being captured by on-board cameras 112A, 112B, and optionally 112C of the motor vehicle 110 of FIG. 1, sent to local computer system 114, transmitted from to local computer system 114 to distal computing system 210. Distal computing system 210 uses data captured by one or more of on-board cameras 112A, 112B, and 112C to produce a risk assessment, and transmits information relating to the risk assessment to the driver (not shown) via display 116 and/or sound producing device 118. The information can be a message to be displayed on display 116, and/or spoken or otherwise rendered via sound producing device 118.

Distal computing system 210 preferably uses AI or other forms of machine learning to determine the risk assessment from data captured by one or more of on-board cameras 112A, 112B, and 112C. Contemplated analytic techniques include neural networks such as Transformers, taking as input a sequence of video frames, and which are trained to predict the probability of accidents, near-accidents, or events that are correlated with accidents or near-accidents (such as harsh braking).

The image data used to train the AI or other forms of machine learning preferably include video data, but can additionally or alternatively include still photographs. To simplify processing, training can be trained on subsamples of the image data received or transmitted by the local computer system 114. Training can also include a training corpus that is not derived from image data produced by the 112A-112C.

Distal computing system 210 can optionally use information about the driver and/or the vehicle in assessing risk. For example, Distal computing system 210 could use age, gender, or past driving experiences in the risk assessment. Distal computing system 210 could also use type or age of the vehicle in the risk assessment. Because of the individualized application to different drivers and vehicles, the Distal computing system 210 could assign different risk levels to different drivers in similar circumstances.

The terms artificial intelligence and AI references mean computer systems where responses are not programmatically determinative, but are instead gleaned from correlations inferred over time as additional data is processed. AI contemplated herein includes processes that run on any combination of servers, services, interfaces, portals, platforms, or other systems formed from computing devices.

It is also contemplated that some or all of the functions of the distal computing system 210 could be accomplished at or in the vehicle, as for example using local computing system 114.

Messages delivered to the driver can be positive, negative, or neutral. Some contemplated messages include honking of the vehicle's horn, beeping, human voice comments, flashing of lights, and textual and/or image/video messages on a display. Messages can also be delivered to the driver when the driver is not driving. For example, a video could be delivered to a user sitting at home, depicting a dangerous behavior such as following closely or tailgating. Even though such behaviors might have been done at reasonable speeds, and they might not have involved hard breaking, they could still be interpreted as potentially dangerous enough to impact the driver's risk assessment.

In another aspect of the inventive subject matter, driver risk assessment prior to delivery of messages to the driver can be compared with the same driver's driver risk assessment following delivery of messages to the driver, to detect a change in behavior of the driver.

Also, driver risk assessment can be provided to an insurer, so that the insurer can use the risk assessment as a factor in determining an insurance premium offered or charged to the driver.

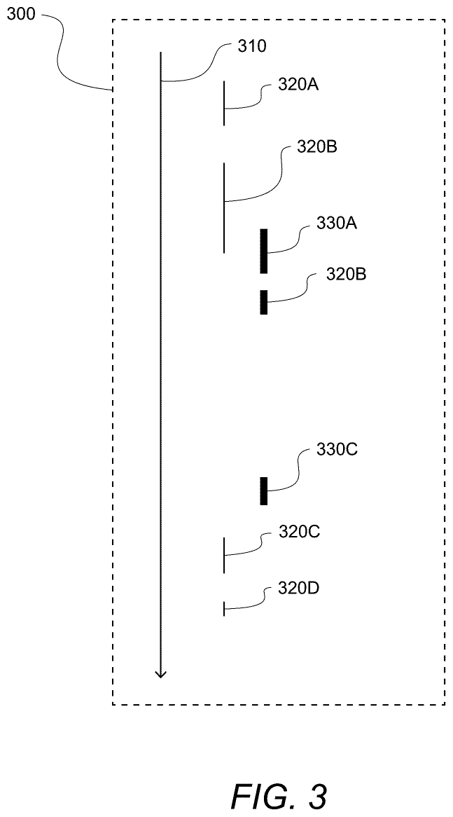

FIG. 3 is a diagram 300 of an exemplary timeline 310 of a consecutive 3 hour period of vehicle motion, depicting segments of image data capture 320A-320D used in producing the risk assessment, and instances of adverse driving events 330A-330C.

In this example none of the image data used in producing the risk assessment is triggered by an adverse driving event. Instances of image data capture 320A-320D can be triggered randomly, pseudo-randomly, at pre-determined intervals, or by some other algorithm as long as at least a significant percentage of the image data used in producing the risk assessment is not triggered by an adverse driving event. Contemplated significant percentage are 20%, 50%, 75%, 90%, and 100%.

Segments of image data capture can the same or different lengths, and can be separated by the same or different length intervals. In FIG. 3, for example, segments 320A and 320C have the same length, which differs from 320A and 320B. And the interval between segments 320A and 320B is the same as the interval between segments 320C and 320D, but different from the interval between segments 320B and 320C Image data captured during segment 320B coincidentally overlaps in time with adverse driving event 330A, but is not triggered by occurrence of adverse event 330A. In FIG. 3, there is no image capture during adverse driving events 330B and 330C.

A key benefit of reducing or eliminating the use of adverse driving events to trigger capturing of image segments is that the image data is a better representation of ordinary driving. One benefit is that because adverse driving events can be infrequent for a given driver, data collected during ordinary driving is much easier to collect.

A second, surprising benefit is that data collected during ordinary driving provides more accurate assessment of risk. For example, consider a driver operating a motor vehicle at a speed well over a posted speed limit. If driving at that speed is considered to be an adverse driving event, then a prior art analytical system might assess that driver to have a high driving risk. However, if the driving occurs during the day with no fog or other adverse atmospheric conditions, and the road is clear of nearby vehicles, pedestrians or other hazards, assessing that driver with a high driving risk might be inappropriate. Systems and methods claimed herein would instead capture image data showing good driving conditions, and might therefore more accurately assess the driver as having a low driving risk.

In addition, assume that the driver is operating the vehicle over the posted speed limit for a period of an hour or more. A prior art system that triggered recording and analyzing image data based upon adverse events would record data from the entire period. However, systems and methods claimed herein would capture and process image data using one or more segments involving much less data, greatly reducing the processing (and potentially transmission) burden.

This reduction in captured and analyzed data is thought to be critical for a realistic rollout of risk assessments. If ordinary driving of thousands or even millions of drivers often involves behaviors considered to comprise adverse driving events, and adverse driving events triggers collection and analysis of data during adverse driving events, it is just not feasible to collect and analyze all that data. In contract, accurate assessment of driving risk could be obtained over only a few weeks using systems and methods described herein, with relatively short, 3, 5, 10, or 20 hours of accumulated lengths of the image segments.

Although a major focus of the inventive subject matter is promoting driving safety, systems and methods are contemplated herein in which an AI model uses transformers to estimate an insurance risk, and then uses the insurance risk as a factor in deriving a monetary or safety-related risk factor. The monetary or safety-related risk factor can then be used in deriving an insurance payout amount.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N. or B plus N, etc.

What is claimed is:

1. A method of reducing a processing burden in identifying driving risk for a driver of a motor vehicle, comprising:
capturing image data of an environment of the motor vehicle while the motor vehicle is in motion;
processing, by a computing system, segments of the captured image data to produce a risk assessment of the driver; and
wherein capturing of at least 20% of the image data used in producing the risk assessment is not triggered by an adverse driving event.

2. The method of claim 1, wherein the computing system is at least partially distal to the motor vehicle.

3. The method of claim 1, wherein at least first and second ones of the segments processed to produce the risk assessment, have different lengths.

4. The method of claim 1, wherein at least first, second, and third ones of the segments are processed to produce the risk assessment, and a first interval between the first and second segments has a different length from a second interval between the second and third segments.

5. The method of claim 1, wherein a start time of at least one of the processed segment is at least partially random.

6. The method of claim 1, wherein a processor in or on the vehicle at least partially determines when at least one of the processed segments begins.

7. The method of claim 1, wherein at least one of the processed segments comprises video data.

8. The method of claim 1, wherein each of the processed segments comprises a still photograph.

9. The method of claim 1, wherein the computing system uses machine learning software to derive the risk assessment.

10. The method of claim 1, wherein the computing system uses artificial intelligence software to derive the risk assessment.

11. The method of claim 1, wherein the computing system derives the risk assessment from at least 3 hours of accumulated lengths of the provided segments.

12. The method of claim 1, wherein the computing system derives the risk assessment from at least 10 hours of accumulated lengths of the provided segments.

13. The method of claim 1, wherein a processor of the computing system, disposed in or on the vehicle, at least partially derives the risk assessment.

14. The method of claim 1, wherein the computing system does not use an image of driver distraction to produce the risk assessment.

15. The method of claim 1, wherein the computing system produces the risk assessment at least partially based upon analysis of the processed segments with respect to at least one of ambient traffic density, off-road hazard, on-road hazard, complexity of a roadway upon which the vehicle is being driven, behavior of a vehicle within sight range of a driver of the vehicle, and existence of pedestrians within sight range of the driver.

16. The method of claim 1, wherein the computing system produces the risk assessment at least partially based upon analysis of the processed segments with respect to at least three of ambient traffic density, off-road hazard, on-road hazard, complexity of a roadway upon which the vehicle is being driven, behavior of a vehicle within sight range of a driver of the vehicle, and existence of pedestrians within sight range of the driver.

17. The method of claim 1, wherein the adverse driving event is selected from the list consisting of speeding, driver distraction, hard braking, swerving, collision, and near collision.

18. The method of claim 1, further comprising using the risk assessment to trigger delivery of a message to the driver; and

19. The method of claim 17, wherein the message comprises a non-verbal sound.

20. The method of claim 17, wherein the message comprises a verbal phrase.

21. The method of claim 17, wherein the message comprises an image visible to the driver.

22. The method of claim 17, wherein the message comprises sounding of a horn of the vehicle.

23. The method of claim 17 further comprising triggering delivery of the message to the driver while the driver is driving the motor vehicle.

24. The method of claim 17 further comprising triggering delivery of the message to the driver while the driver is not driving the motor vehicle.

25. The method of claim 17 further comprising detecting a change in behavior of the driver following triggering delivery of the message to the driver.

26. The method of claim 17 further comprising providing the risk assessment to an insurer, and the insurer using the risk assessment as a factor in determining an insurance premium offered or charged to the driver.

27. A computing system carried by on in a motor vehicle, programmed to:
capture segments of image data of an environment of the motor vehicle while the motor vehicle is in motion;
either process, or transmit to a distal computing system for processing, the captured segments to produce a risk assessment of the driver; an
wherein capturing at least 20% of the image data used in producing the risk assessment is not triggered by an adverse driving event.
